(19) United States
(12) Patent Application Publication
(10) Pub. No.: US 2019/0221084 A1
(43) Pub. Date: Jul. 18, 2019

(54) SYSTEMS AND METHODS FOR DYNAMIC ALARM NOTIFICATIONS

(71) Applicant: Honeywell International Inc., Morristown, NJ (US)

(72) Inventors: Fred Merkle, Chicago, IL (US); Zia Karim, Saint Charles, IL (US)

(21) Appl. No.: 15/873,230

(22) Filed: Jan. 17, 2018

(51) Int. Cl. G08B 5/38; G02F 1/1335; G08B 1/08

(52) U.S. Cl. CPC G08B 5/38; G08B 1/08; G02F 1/133609

(57) ABSTRACT

Systems and methods are provided for dynamically changing alarm notifications by dynamically changing notification indicators based on a type of alert generated or a type of security system that generated the alert. Some methods can include a notification appliance receiving an alarm message, determining a type of alarm associated with the alarm message, and illuminating one of a plurality of labels based on the type of alarm associated with the alarm message.

### FIELD

The present invention relates generally to notification appliances. More particularly, the present invention relates to visual notification appliances, such as strobe light devices.

### BACKGROUND

Security systems are known to detect threats within a secured area, and such threats include events that represent a risk to human safety or a risk to assets.

Security systems typically include one or more security sensors that detect the threats within the secured area. For example, smoke, motion, and/or intrusion sensors are distributed throughout the secured area in order to detect the threats. Furthermore, security systems typically include notification appliances, such as sounders and strobe lights, to notify occupants of an emergency.

Some buildings include multiple security systems (e.g. fire system, evacuation system, agent release system, etc.), and each of the multiple security systems generally has its own respective set of notification appliances, which leads to additional wiring, additional power supplies, and additional cost. As such, there is a need for fewer notification appliances in buildings with multiple security systems.

### BRIEF DESCRIPTION OF THE DRAWINGS

FIG. 1 is a block diagram of a system in accordance with disclosed embodiments;

FIG. 2 is a flow diagram of a method in accordance with disclosed embodiments;

FIGS. 3A-3D are views of a notification appliance having labels in accordance with disclosed embodiments;

FIG. 4 is a flow diagram of a method in accordance with disclosed embodiments; and

FIG. 5 is a view of a notification appliance having a display in accordance with disclosed embodiments;

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods that dynamically change notification indicators based on a type of alert generated or a type of security system that generated the alert. In some embodiments, systems and methods disclosed herein can include a notification appliance, such as a strobe light, that illuminates one of a plurality of labels, where each of the plurality of labels can correspond to a respective one of a plurality of notification indicators (e.g. a fire indicator, an alert indicator, a chemical agent release indicator, etc.). Furthermore, in some embodiments, the plurality of labels can have different colors or illuminate in different colors.

In some embodiments, the plurality of labels can include a plurality of semi-transparent, plastic labels. For example, a first of the plurality of semi-transparent, plastic labels can glow red by only allowing light having red wavelengths to pass through the first of the plurality of semi-transparent, plastic labels. Similarly, a second of the plurality of semi-transparent, plastic labels can glow amber by only allowing the light having amber wavelengths to pass through the second of the plurality of semi-transparent, plastic labels. Furthermore, a third of the plurality of semi-transparent, plastic labels can glow blue because only light having blue wavelengths passes through the third semi-transparent, plastic label. Accordingly, in some embodiments, a white light emitting diode (LED) can emit the light illuminating each of the plurality of semi-transparent, plastic labels.

Additionally or alternatively, in some embodiments, the plurality of semi-transparent, plastic labels can illuminate only in the presence of a light source having a specific wavelength or a specific range of wavelengths. For example, a first label can illuminate red when the first of the plurality of semi-transparent, plastic label receives light having a red wavelength, a second label can illuminate amber when the second of the plurality of semi-transparent, plastic label receives light having an amber wavelength, and a third label can illuminate blue when the third of the plurality of semi-transparent, plastic labels receives light having a blue wavelength. Accordingly, in some embodiments, the plurality of semi-transparent, plastic labels can substantially overlap, and in some embodiments, the plurality of light sources can include different color LEDs (e.g. red, amber, blue) positioned in close proximity within the notification appliance and selectively activated.

Additionally or alternatively, in some embodiments, the plurality of labels can include a plurality of transparent labels, and the plurality of light sources illuminating the plurality of transparent labels can include a plurality of LEDs, where each of the plurality of LEDs can have a respective color. For example, a first, red one of the plurality of LEDs can illuminate a first of the plurality of transparent labels. Similarly, a second, amber one of the plurality of LEDs can illuminate a second of the plurality of transparent label. Furthermore, a third, blue one of the plurality of LEDs can illuminate a third of the plurality of transparent labels.

Additionally or alternatively, in some embodiments, the notification device may include a liquid crystal display (LCD) that may display a plurality of different words and a plurality of different background colors. For example, during a fire situation, the LCD may display the word “FIRE” in white lettering over a red one of the plurality of different background colors. Similarly, during a chemical agent release situation, the LCD may display the word “AGENT” in white lettering over a blue one of the plurality of different backgrounds. As another example, during a fire situation, the LCD may display a symbol or icon illustrating a fire (e.g. a fire emoji). Alternatively, in some embodiments, the notification device may include a bi-stable display that displays the plurality of different words by either darkening or lighting various pixels of the bi-stable display.

It is to be understood that systems and methods disclosed herein can include more or less than three of the plurality of labels and more or less than three of the plurality of light sources. Furthermore, it is to be understood that each of the plurality of semi-transparent, plastic labels can allow the light having additional or alternate color wavelengths to pass, the plurality of light sources can emit the light having additional or alternate wavelengths or ranges of wavelengths, and the plurality of LEDs can have additional or alternate colors.

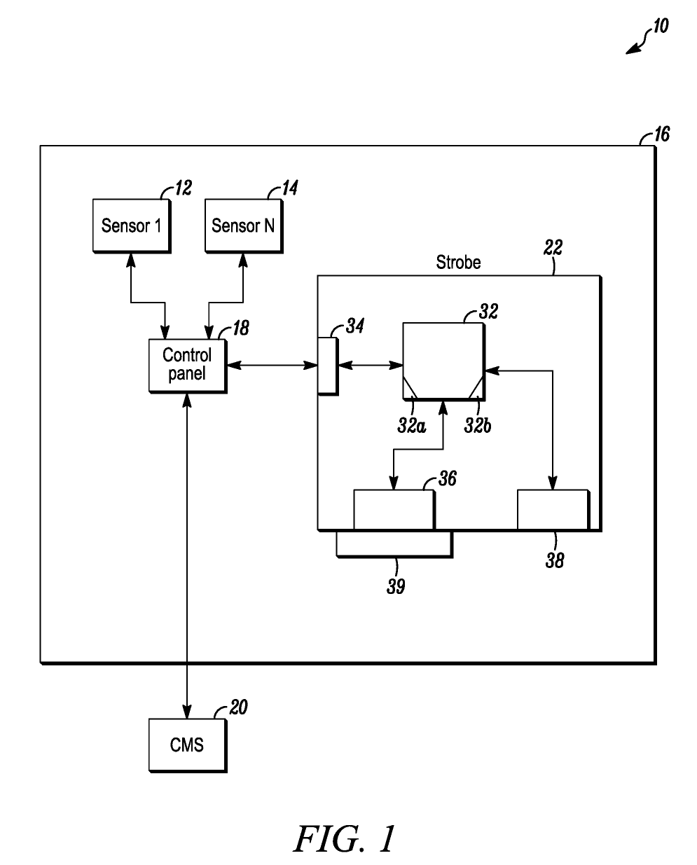

FIG. 1 is a block diagram of a security system 10 in accordance with disclosed embodiments. As seen in FIG. 1, the security system 10 can include one or more wireless security sensors 12, 14 that monitor a secured area 16 for threats, and in some embodiments, the wireless security sensors 12, 14 can include intrusion, camera, motion, fire, smoke, and gas detectors. The wireless security sensors 12, 14 can communicate with a control panel 18, and the control panel 18 can monitor for activation of the wireless security sensors 12, 14.

In some embodiments, the control panel 18 may send a notification message to a central monitoring station 20 upon the activation of one of the wireless security sensors 12, 14, and the central monitoring station 20 may respond by summoning the appropriate help. For example, if the one of the wireless security sensors 12, 14 detects a fire, then the central monitoring station 20 may summon a local fire department. Alternatively, if the one of the wireless security sensors 12, 14 detects an intrusion, then the central monitoring station 20 may summon the police.

In addition to sending the notification message to the central monitoring station 20, the control panel 18 can send an alarm message to an alarm notification appliance 22 included in the secured area 16. In response, the alarm notification appliance 22 can emit noise or light to inform occupants of the secured area 16 of an emergency situation.

The alarm notification appliance 22 can include control circuitry 32, which can include one or more programmable processors 32a and executable control software 32b as would be understood by one of ordinary skill in the art. The executable control software 32b can be stored on a transitory or non-transitory computer readable medium, including, but not limited to local computer memory, RAM, optical storage media, magnetic storage media, and the like. In some embodiments, the control circuitry 32, the programmable processor 32a, and the control software 32b can execute and control some of the methods disclosed herein.

The alarm notification appliance 22 can also include a transceiver 34, a label light 36, a flashing light source 38, and a plurality of labels 39. In operation, the transceiver 34 can receive data (e.g. the alarm message) from the control panel 18 and provide the data to the control circuitry 32, and the control circuitry 32, the programmable processor 32a, and the control software 32b can determine a type of the alarm message based on the data included in the alarm message, such as a header of the alarm message, or based on which system (e.g. fire system, agent release system) transmitted the alarm message to the notification appliance 22. For example, the control circuitry 32, the programmable processor 32a, and the control software 32b can determine whether the alarm message is a fire alarm message, an alert alarm message, a chemical agent release alarm message, an intrusion alarm message, a hostage situation alarm message, a weather emergency (e.g. tornado, earthquake) alarm message, or any other type of emergency alarm message as would be understood by one or ordinary skill in the art.

In some embodiments, the flashing light source 38 can flash or flicker during an alarm situation, and in some embodiments, the flashing light source 38 can include a strobe light.

In some embodiments, the label light 36 can include a single light, such as a white LED, and in some embodiments, the plurality of labels 39 can include a plurality of different color, semi-transparent, plastic labels. For example, a first of the plurality of different color, semi-transparent, plastic labels may be illuminated by the white LED and glow red by only allowing the light having red wavelengths to pass therethrough. Similarly, a second of the plurality of different color, semi-transparent, plastic labels may be illuminated by the white LED and glow amber by only allowing the light having amber wavelengths to pass therethrough. Furthermore, a third of the plurality of different color, semi-transparent, plastic labels may be illuminated by the white LED and glow blue by only allowing the light having blue wavelengths to pass therethrough.

Additionally or alternatively, the plurality of labels 39 can include a plurality of transparent labels, the label light 36 can include a plurality of different color LEDs, and each of the plurality of different color LEDs can illuminate a respective one of the plurality of labels 39. For example, a first, red one of the plurality of different color LEDs can illuminate a first of the plurality of transparent labels 39. Similarly, a second, amber one of the plurality of different color LEDs can illuminate a second of the plurality of transparent labels. Furthermore, a third, blue one of the plurality of different color LEDs can illuminate a third of the plurality of transparent labels.

Additionally or alternatively, the plurality of labels 39 can include a display.

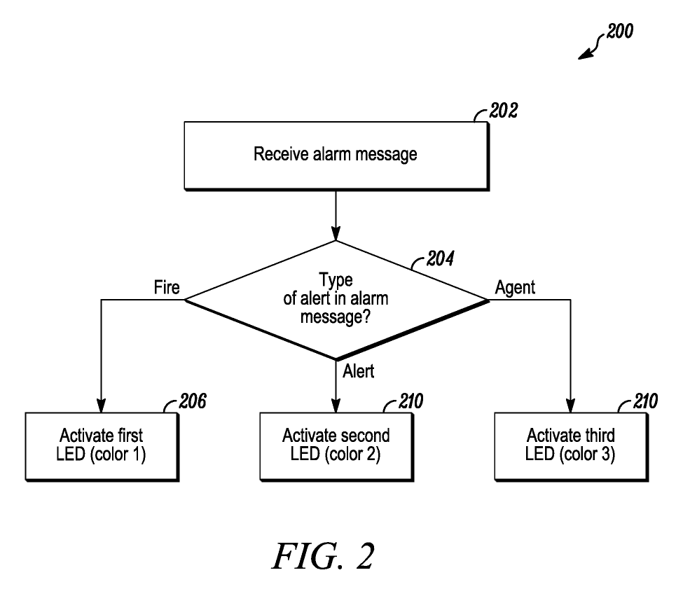

FIG. 2 is a flow diagram of a method 200 for dynamically displaying notification indicators in accordance with disclosed embodiments. As seen in FIG. 2, the method 200 can include a processor (e.g. the programmable processor 32a) of a notification appliance (e.g. the notification appliance 22) receiving an alarm message from a control panel (e.g. the control panel 18) as in 202 and the processor determining a type of the alarm message as in 204. For example, in some embodiments, the processor can determine the type of the alarm message by determining which security system sent the alarm message or by referencing metadata within the alarm message indicating the type of the alarm message. When the processor determines that the alarm message is a first type of the alarm message (e.g. a fire emergency), the processor can activate a first of a plurality of lights (e.g. the label light 36) to illuminate a first of a plurality of labels (e.g. the plurality of labels 39) as in 206. Furthermore, when the processor determines that the alarm message is a second type of the alarm message (e.g. an alert), the processor can activate a second of the plurality of lights to illuminate a second of the plurality of labels as in 208. Further still, when the processor determines that the alarm message is a third type of the alarm message (e.g. a chemical agent release), the processor can activate a third of the plurality of lights to illuminate a third of the plurality of labels as in 210.

FIG. 2 is described in connection with three of the plurality of lights and three of the plurality of labels. However, it is to be understood that system and methods disclosed herein are not so limited and can include more or less than three of the plurality of lights and three of the plurality of labels.

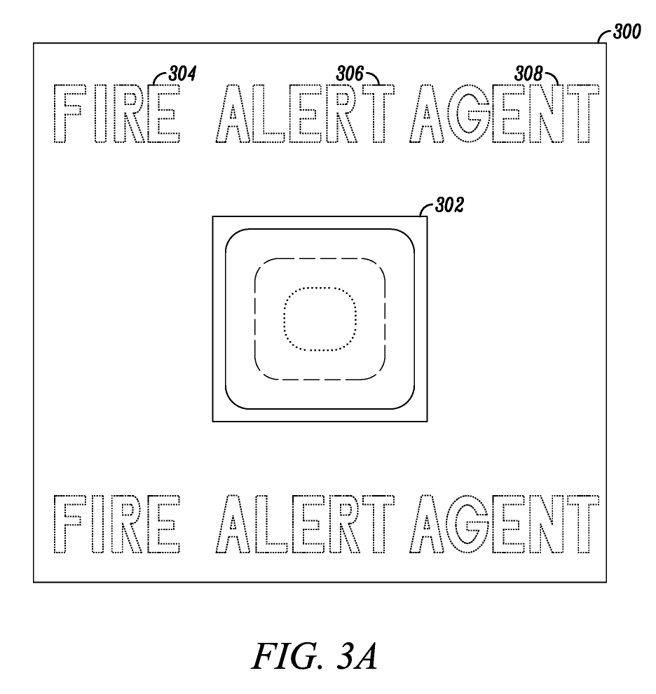

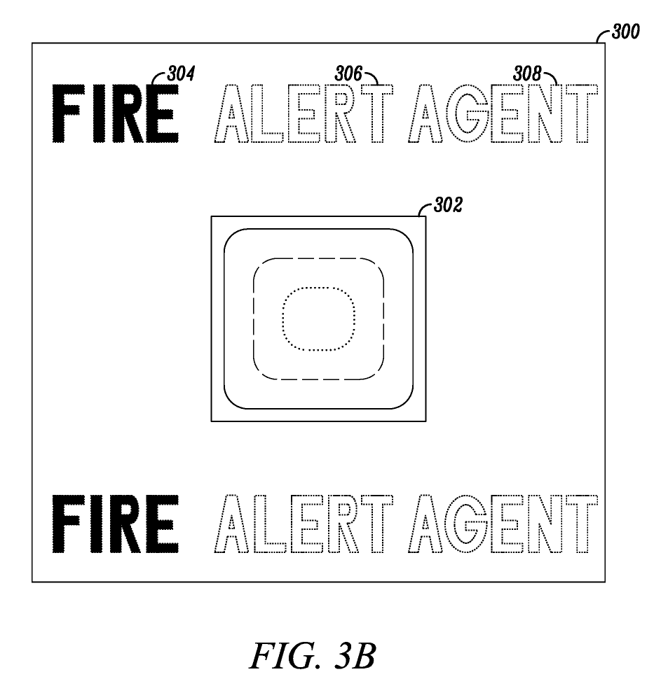

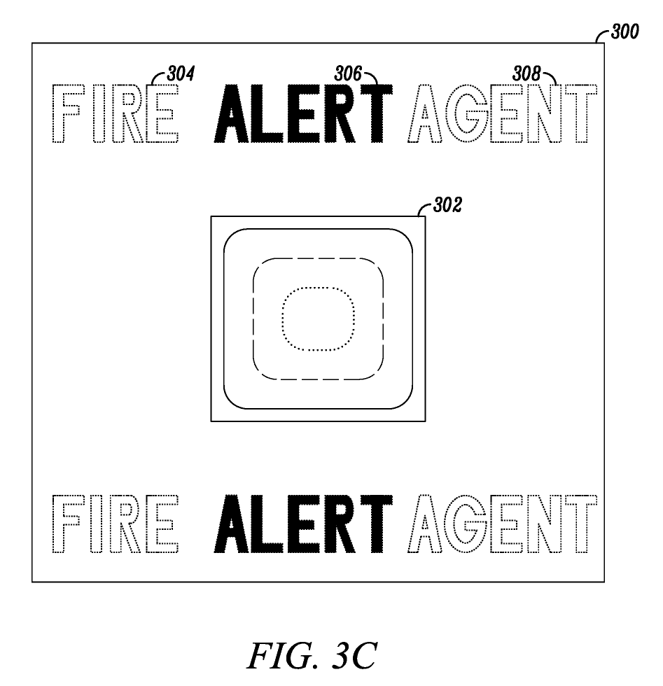

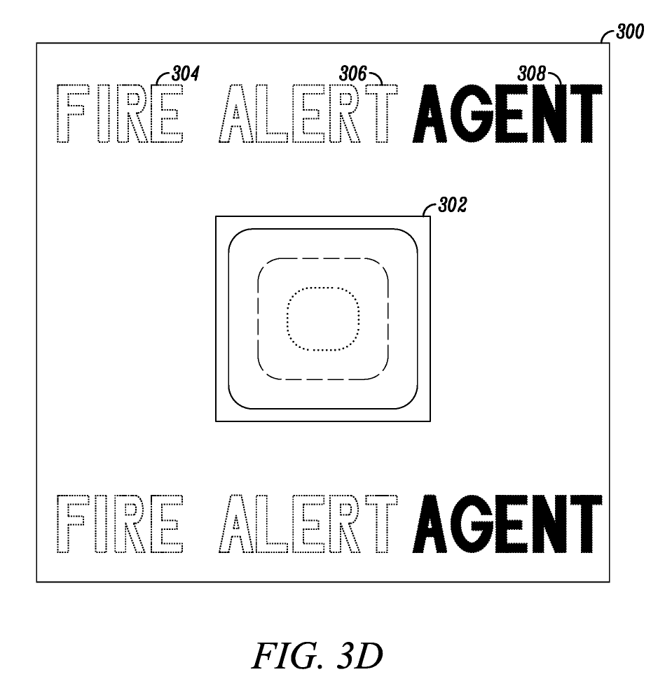

FIGS. 3A-3D are views of a notification appliance 300 in accordance with disclosed embodiments. As seen in FIG. 3A, the notification appliance 300 can include a strobe light 302, a first label 304, a second label 306, and a third label 308. In FIG. 3A, none of the labels 304-308 are illuminated (as illustrated by dashed lines).

However, a processor of the notification appliance 300 can selectively illuminate the labels 304, 306, 308 according to the method 200 of FIG. 2. For example, when the processor determines that an alarm message received by the notification appliance 300 is a first type of the alarm message (e.g. a fire emergency), the processor can illuminate the first label 304, as seen in FIG. 3B. Similarly, when the processor determines that the alarm message is a second type of the alarm message (e.g. an alert), the processor can illuminate the second label 306, as seen in FIG. 3C. Furthermore, when the processor determines that the alarm message is a third type of the alarm message (e.g. a chemical agent release), the processor can illuminate the third label 308, as seen in FIG. 3D. In some embodiments, the first label 304 may be a first color (e.g. red), the second label 306 may be a second color (e.g. amber), and the third label 308 may be a third color (e.g. blue).

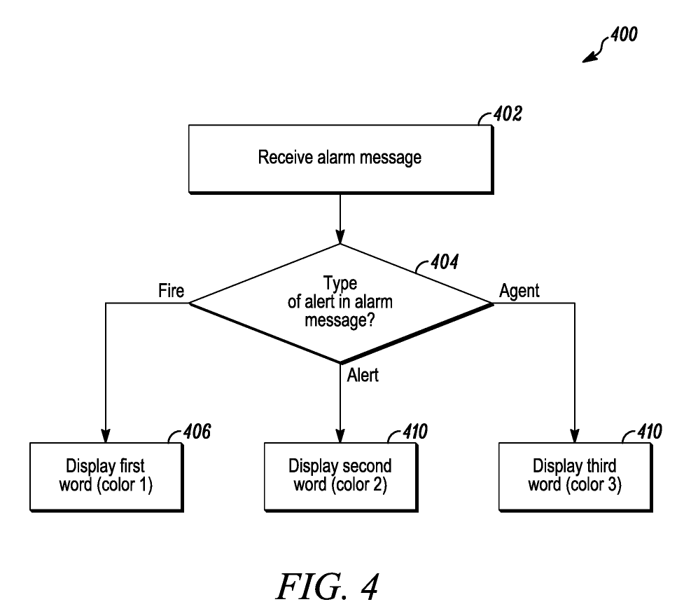

FIG. 4 is a flow diagram of a method 400 for dynamically displaying notification indicators in accordance with disclosed embodiments. As seen in FIG. 4, the method 400 can include a processor (e.g. the programmable processor 32a) of a notification appliance (e.g. the notification appliance 22) receiving an alarm message from a control panel (e.g. the control panel 18) as in 402 and the processor determining a type of the alarm message as in 404. When the processor determines that the alarm message is a first type of the alarm message (e.g. a fire emergency), the processor can display a first word (e.g. “FIRE”) or a first symbol (e.g. a fire emoji) and a first color on a display of the notification appliance as in 406. Similarly, when the processor determines that the alarm message is a second type of the alarm message (e.g. an alert), the processor can display a second word (e.g. “ALERT”) or a second symbol (e.g. a siren emoji) and a second color on the display as in 208. Furthermore, when the processor determines that the alarm message is a third type of the alarm message (e.g. a chemical agent release), the processor can display a third word (e.g. “AGENT”) or a third symbol (e.g. a gas emoji) and a third color on the display as in 210.

FIG. 4 is described in connection with three words and three colors. However, it is to be understood that system and methods disclosed herein are not so limited and can include more or less than three words and three colors.

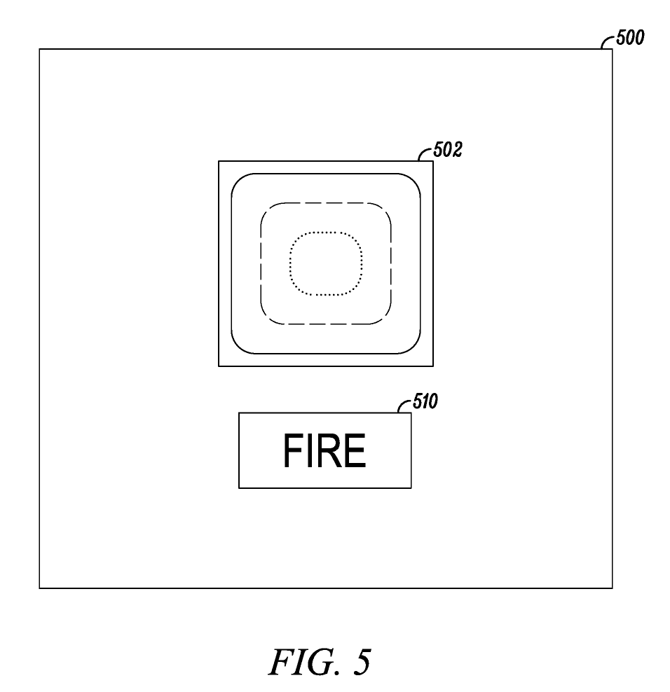

FIG. 5 is a view of a notification appliance 500 in accordance with disclosed embodiments. As seen in FIG. 5, the notification appliance 500 can include a strobe light 502 and a display 510, and the display 510 can display a word (e.g. “FIRE”) and a color. In some embodiments, the display 510 can include an LCD or bi-stable display.

Although a few embodiments have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A method comprising:
a notification appliance receiving an alarm message;
the notification appliance determining a type of alarm associated with the alarm message; and
the notification appliance illuminating one of a plurality of labels based on the type of alarm associated with the alarm message,
wherein each of the plurality of labels only illuminates when backlit by a respective lighting device having a wavelength within a range of wavelengths allowed to pass through a particular label of the plurality of labels thereby allowing the wavelength of light to pass through the particular label.

2. (canceled)

3. The method of claim 1 further comprising the notification appliance using a respective one of a plurality of light emitting diodes (LEDs) to illuminate the one of the plurality of labels.

4. (canceled)

5. The method of claim 1 wherein each of the plurality of labels includes a respective semi-transparent label.

6. (canceled)

7. (canceled)

8. The method of claim 1 wherein the plurality of labels substantially overlap.

9. The method of claim 3 wherein each of a plurality of LEDs emits the respective light having the respective color.

10. (canceled)

11. (canceled)

12. A notification appliance comprising:
a plurality of labels;
a transceiver that receives an alarm message;
a programmable processor; and
executable control software stored on a non-transitory computer readable medium;
wherein the programmable processor and the executable control software determine a type of alarm associated with the alarm message,
wherein the programmable processor and the executable control software illuminate one of the plurality of labels based on the type of alarm associated with the alarm message, and
wherein each of the plurality of labels only illuminates when backlit by a respective lighting device having a wavelength within a range of wavelengths allowed to pass through a particular label of the plurality of labels thereby allowing the wavelength of light to pass through the particular label.

13. (canceled)

14. The notification appliance of claim 12 further comprising:
a plurality of light emitting diodes (LEDs).

15. (canceled)

16. The notification appliance of claim 12 wherein each of the plurality of labels includes a respective semi-transparent label.

17. (canceled)

18. The notification appliance of claim 14 wherein each of the plurality of LED's emits the respective light having the respective color and illuminates a respective one of the plurality of labels with the respective light having the respective color.

19. The notification appliance of claim 18 wherein the plurality of labels substantially overlap.

20. (canceled)
